(19) United States
(12) Patent Application Publication
(10) Pub. No.: US 2018/0174000 A1
(43) Pub. Date: Jun. 21, 2018

(54) DEFECT IMAGE CLASSIFICATION DEVICE AND DEFECT IMAGE CLASSIFICATION METHOD

(71) Applicant: HITACHI HIGH-TECHNOLOGIES CORPORATION, Minato-ku, Tokyo (JP)

(72) Inventors: Yuji TAKAGI, Tokyo (JP); Minoru HARADA, Tokyo (JP); Takehiro HIRAI, Tokyo (JP)

(21) Appl. No.: 15/579,047

(22) PCT Filed: Jun. 4, 2015
(86) PCT No.: PCT/JP2015/066244

§ 371 Date: Dec. 1, 2017

(51) Int. Cl. G06K 9/62; G01N 21/88; G01N 23/2251

(52) U.S. Cl. CPC G06K 9/6262; G01N 21/8851; G01N 2021/8854; G06K 9/6267; G01N 2021/8887; G01N 23/2251

(57) ABSTRACT

In a defect classification operation in which ADC and visual classification are both used, a problem with the visual classification in the related art is solved, and then the high-reliability performance evaluation of the ADC and the update of the ADC learning data set are made possible, using both the ADC and the visual classification, or both the ADC and one other classification apparatus.

An apparatus that classifies defect images is configured to include: a storage unit in which the defect images that are obtained by being captured with separate image capture means are stored; an image selection unit that selects images from among the defect images that are stored in the storage unit, using information on defect classes into which defects are classified in a plurality of separate defect classification means; an image classification unit that classifies the images which are selected in the image selection unit, based on a classification recipe; a classification performance evaluation unit that evaluates classification performance of the image classification unit based on a result of the classification of the images; and a learning update unit that updates the classification recipe of the image classification unit using the images that are selected in the image selection unit in a case where the result of the evaluation in the classification performance evaluation unit does not satisfy a reference that is in advance set.

### TECHNICAL FIELD

The present invention relates to a defect image classification apparatus and a defect image classification method that automatically classify an image that results from image-capturing a defect which occurs while manufacturing a semiconductor wafer.

### BACKGROUND ART

In a process of manufacturing a semiconductor, in order to accomplish a yield improvement, it is important to investigate a cause of occurrence of a defect to a semiconductor wafer and thus to take measure to cope with this situation. Analysis of the defect is made using a visual inspection tool and a defect review tool in a manufacturing field. The visual inspection tool is a tool that inspects a wafer using optical means or an electronic beam and outputs positional coordinates of the detected defect. Because the visual inspection tool needs to inspect an entire surface of the wafer at high speed, pixel resolution of a detection image is lowered to such an extent that the defect detection is possible and an amount of image data per unit area is reduced, thereby accomplishing shortening of the inspection time. For this reason, detailed review of the defect using a detection image that is obtained by the visual inspection tool is difficult.

The detailed review of the defect is performed by the defect review tool. The defect review tool is a tool that image-captures a position which is represented by defect coordinates, at high resolution, based on the defect coordinates which are obtained from the defect review tool, and that outputs the captured image. With the miniaturization of a semiconductor manufacturing process, a defect review tool SEM that uses a scanning electron microscope (SEM) is widely used for this review. The defect review SEM has an automatic defect review (ADR) function of automatically capturing and collecting an image of the defect on the wafer based on the defect coordinates that are obtained from the visual inspection tool and an automatic defect classification (ADC) function of automatically classifying the collected images.

The ADC needs to perform learning that uses the defect image in an initial operation for every classification process, but it is difficult to collect a sufficient amount of image layer data on all defect classes (types) and to perform creating of learning data set. In order to maintain initially-obtained performance until after production application, performance evaluation while the production application is in progress and additional learning are necessary. A problem is that this technique has to be established. A method of monitoring ADC learning data set at the time of the production application is disclosed in PTL 1.

Although the defect class is limited to one classification process, there are various classes. Furthermore, in some cases, variations in shape and brightness are included in one class. For this reason, the ADC is difficult to apply to all processes in terms of an operation. For this reason, a method in which the classification process is divided into an ADC application process and a visual classification process, or the use of both the ADC and the visual classification, such as when division into a defect class that uses a result of the ADC and a defect class that does not use the result of the ADC is performed in one classification process to perform visual classification of only the defect class that does not use the result of the ADC, is proposed. A method of setting a recipe for the ADC on the assumption of the use of both the ADC and the visual classification is disclosed in PTL 2.

### CITATION LIST

### Patent Literature

PTL 1: JP-A-2001-256480

PTL 2: JP-A-2011-155123

Non-patent Literature

NPL 1: W. Tomlinson, B. Halliday, et.al, “In-Line SEM based ADC for Advanced Process Control”, Proc. Of 2000 IEEE/SEMI Advanced Semiconductor Manufacturing Conference, pp. 131-137(2000)

### SUMMARY OF INVENTION

### Technical Problem

In an automatic defect classification technology that is applied to a visual inspection process in a semiconductor process, whether or not a recipe for automatic defect classification process is suitably set for an image that is a target for automatic defect classification is evaluated periodically or at an arbitrary timing after the time elapses and the recipe needs to be updated in a case where the recipe for the automatic defect classification process is unsuitable. Performance evaluation of the automatic defect classification in the related art is performed with a visual defect class (type) assigned by one operator being used as a reference, and recipe update is performed based on this visual defect class. However, there is a problem in that an error due to an individual difference or the like is included in the visual defect class and in that the performance evaluation of the high-precision automatic defect classification and the recipe update for providing the high classification performance cannot be performed.

PTL 1 discloses a technology in which, in order to stably maintain the classification performance of the ADC at the time of application for mass production, a defect image feature that is an ADC classification target and a feature that is registered in learning data set are compared with each other, statistical changes in the image that is the ADC target and in the learning data set are detected, an instruction for learning data set update is performed, and thus a stable operation can be performed without decreasing the classification performance of the ADC also at the time of the application for mass production.

PTL 1 discloses a method of using a result of the ADC classification or a result of the visual classification for a defect class of the image that is the ADC target. However, the use of the result of the ADC classification that is a performance evaluation target cannot exclude erroneous classification due to the ADC at all, a classification accuracy rate of the visual classification, as disclosed in NPT 1, is at most 60%, suitable performance evaluation of the ADC is difficult although any is used.

PTL 2 discloses a technology in which division into a defect class suitable the ADC and a defect class unsuitable for the ADC is performed, an operation in which the defect class unsuitable for the ADC is checked in the visual classification is assumed, a recipe that can decrease the number of defect images that are transferred to the visual classification, from among a plurality of ADC recipes that are in advance prepared, and thus optimization of a parameter of the ADC is accomplished. In a defect classification operation in which the ADC and the visual classification are both used, stable operation of the ADC and a decrease in visual classification workload are compatible with each other. However, when the parameter of the ADC is optimized, the result of the visual classification is used, and an influence of the visual classification that is at a low classification accuracy rate cannot be avoided. Furthermore, a method of the performance evaluation that is necessary after the application for mass production and a method of updating the ADC learning data set are not disclosed.

The description is provided above using the terms, such as learning data set, ADC recipe, and ADC parameter, that are used in each of the literature documents, when referring to the two patent literature documents. These may be interpreted, in a broad sense, as data necessary for causing the ADC to operate. However, more precisely, the ADC parameter can be defined as a parameter relating to image processing that is necessary until an image feature is calculated. Furthermore, the learning data set can be defined as a parameter set that is used by a classification algorithm of the ADC, which is derived from a teaching image feature. Furthermore, the ADC recipe can be defined as a data set for causing the ADC, which includes both the ADC parameter and the learning data set, to operate.

An object of the present invention is to provide a defect image classification apparatus and a defect image classification method that solves a problem with the visual classification in the related art and then make it possible to perform high-reliability performance evaluation of ADC and update of ADC learning data set, using both the ADC and visual classification, or both the ADC and one other classification apparatus, in a defect classification operation in which the ADC and the visual classification are both used.

### Solution to Problem

In order to accomplish the object described above, according to an aspect of the present invention, there is provided a defect image classification apparatus that classifies defect images, including: a storage unit in which the defect images that are obtained by being captured in separate image capture means are stored; an image selection unit that selects images from among the defect images that are stored in the storage unit, using information on defect classes into which defects are classified in a plurality of separate defect classification means; an image classification unit that classifies the images which are selected in the image selection unit, based on a classification recipe; a classification performance evaluation unit that evaluates classification performance of the image classification unit based on a result of the classification of the images; and a learning update unit that updates the classification recipe of the image classification unit using the images that are selected in the image selection unit in a case where the result of the evaluation in the classification performance evaluation unit does not satisfy a reference that is in advance set.

Furthermore, in order to accomplish the object described above, according to another aspect of the present invention, there is provided a defect image classification apparatus that classifies defect images, including: a storage unit in which the defect images that are obtained by being captured in separate image capture means are stored; an image selection unit that selects images from among the defect images that are stored in the storage unit, using information on defect classes into which defects are classified in a plurality of separate defect classification means; an image classification unit that classifies the images which are stored in the storage unit, based on a classification recipe; and a learning update unit that updates the classification recipe of the image classification unit using the images that are selected in the image selection unit.

Moreover, in order to accomplish the object described above, according to still another aspect of the present invention, there is provided a defect image classification method of classifying defect images, including: storing the defect images that are obtained by being captured in separate image capture means, in a storage unit; selecting images in an image selection unit from among the defect images that are stored in the storage unit, using information on defect classes into which defects are classified in a plurality of separate defect classification means; classifying the images which are selected in the image selection unit, in an image classification unit, based on a classification recipe; evaluating classification performance of the image classification unit, in a classification performance evaluation unit, based on a result of the classification of the images; and updating the classification recipe of the image classification unit in a learning update unit, using the images that are selected in the image selection unit in a case where a result of the evaluation in the classification performance evaluation unit does not satisfy a reference that is in advance set.

Moreover, in order to accomplish the object described above, according to still another aspect of the present invention, there is provided a defect image classification method of classifying defect images, including: storing the defect images that are obtained by being captured with separate image capture means, in a storage unit; selecting images in an image selection unit from among the defect images that are stored in the storage unit, using information on defect classes into which defects are classified in a plurality of separate defect classification means; classifying the images which are stored in the storage unit, in an image classification unit, based on a classification recipe; and updating the classification recipe of the image classification unit in a learning update unit, using the images that are selected in the image selection unit.

### Advantageous Effects of Invention

According to the present invention, with comparison among a plurality of visual classification or results that are obtained by a classification apparatus other than an ADC apparatus, high-reliability performance evaluation of ADC is possible using data that has a few defect class errors. Furthermore, with this data, learning update is performed without ADC learning, and thus classification performance of the ADC can be maintained and improved.

### BRIEF DESCRIPTION OF DRAWINGS

FIG. 1 is a block diagram illustrating a configuration of an automatic defect classification apparatus in a first embodiment of the present invention.

FIG. 2 is a flow diagram illustrating a flow for processing in the first embodiment of the present invention.

FIG. 3 is a table illustrating a method of collating an MDC defect class in the first embodiment of the present invention.

FIG. 4 is a table illustrating an ADC performance evaluation method in the first embodiment of the present invention.

FIG. 5 is a flow diagram illustrating a modification example of the flow for the processing in the first embodiment of the present invention.

FIG. 6 is a flow diagram illustrating a modification example of the flow for the processing in the first embodiment of the present invention.

FIG. 7 is a table illustrating an ADC performance evaluation method that includes an unknown defect class in the first embodiment of the present invention.

FIG. 8 is a flow diagram illustrating a modification example of the flow for the processing in the first embodiment of the present invention.

FIG. 9 is a table illustrating the ADC performance evaluation method that includes a new defect class in the first embodiment of the present invention.

FIG. 10 is a flow diagram illustrating a modification example of the flow for the processing in the first embodiment of the present invention.

FIG. 11 is a table illustrating an MDC defect class evaluation method that uses weight in the first embodiment of the present invention.

FIG. 12 is a table illustrating an ADC performance evaluation method using an MDC defect class that uses the weight in the first embodiment of the present invention.

FIG. 13 is a table illustrating the ADC performance evaluation method using the MDC defect class that uses majority decision in the first embodiment of the present invention.

FIG. 14 is a flow diagram illustrating a flow for processing in a second embodiment of the present invention.

FIG. 15 is a flow diagram illustrating a flow for a processing activation method in a third embodiment of the present invention.

FIG. 16 is a flow diagram illustrating a flow for another processing activation method in the third embodiment of the present invention.

FIG. 17 is a flow diagram illustrating a flow for processing for standardization of a level of an MDC operation that uses an MDC defect inconsistency class in a fourth embodiment of the present invention.

### DESCRIPTION OF EMBODIMENTS

In a method of and an apparatus for classifying defect images according to the present invention, images that are selected using information on a defect class into which a defect is classified in a plurality of separate defect classification means are classified, classification performance is evaluated based on a result of the classification, and an image classification recipe is updated in a case where a result of the evaluation does not satisfy a reference that is in advance set.

Furthermore, in a method of and an apparatus for classifying defect images according to the present invention, an image is selected in an image selection unit from among defect images that are stored in a storage unit using information on defect classes into which defects are classified in a plurality of separate defect classification means, and a classification recipe of an image classification unit is updated in a learning update unit using the selected image.

Embodiments of the present invention will be described below with reference to the drawings.

### First Embodiment

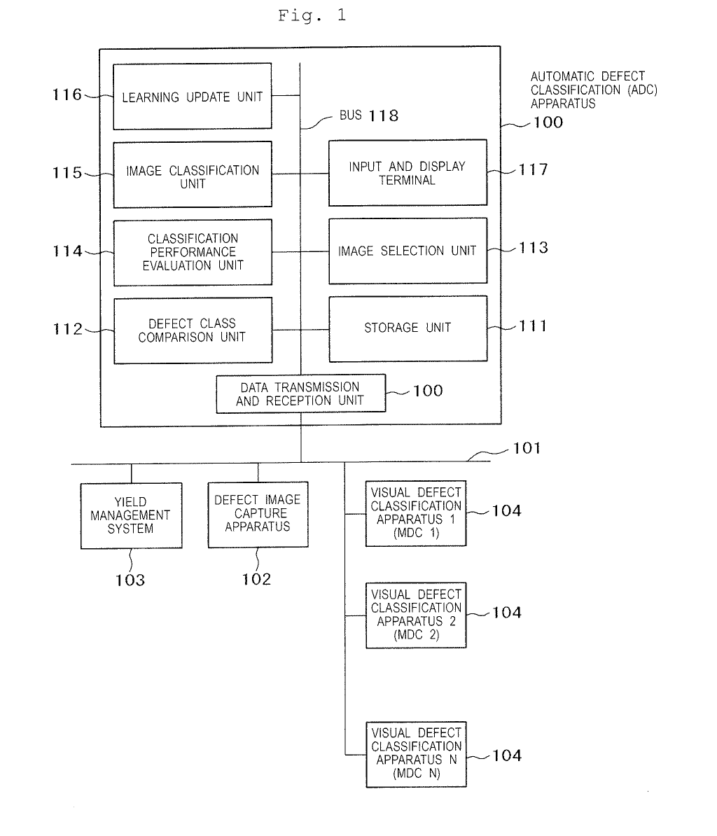

An automatic defect classification (ADC) apparatus 100 according to the present invention is illustrated in FIG. 1. In FIG. 1, in all, a defect image capture apparatus 102, a yield management system 103, and a manual defect classification (MDC) apparatus 104 transmit and receive information through an ADC apparatus 100 and a network 101. A plurality of MDC apparatuses 104 are connected to the network.

In FIG. 1, the ADC apparatus 100, the defect image capture apparatus 102, the yield management system 103, and the MDC apparatus 104 are set to be connected to the network, but a connection may be made to any other means that can exchange information, such as a portable memory device.

The defect image capture apparatus 102 is an apparatus that captures an image of a defect position which is detected in a visual inspection tool (not illustrated), at high magnification and that takes a picture of the external appearance of a defect, such as an optical-type apparatus or a scanning electron microscope (SEM)-type apparatus. The SEM-type device is used for a microscopic device, has a function of automatically capturing the image of the defect position that is detected in the visual inspection tool, and is called a defect review SEM or the like.

The yield management system 103 receives defect coordinates that are output from the visual inspection tool (not illustrated), a defect image that is output from the defect image capture apparatus 102, and defect class (defect type) information that is output from the ADC apparatus 100 and the MDC apparatus 104, and along with this, transmits the defect coordinates according to a request from the defect image capture apparatus 102 and transmits the defect image according to a request from the ADC apparatus 100 and the MDC apparatus 104. The defect coordinates, the defect images, and the defect classes that are accumulated in the yield management system 103 are statistically interpreted, and thus a user can monitor a state of a process.

The MDC apparatus 104 is an apparatus with which an operator performs classification of defect images and assigns defect class information to the defect image. The defect image is received from the ADC apparatus 100, the defect image capture apparatus 102, or the yield management system 103, the defect class is assigned by the operator to the received defect image, and the defect class information is transmitted to the ADC apparatus 100 or the yield management system 103. A plurality of MDC apparatuses 104 from MDC 1 to MDC N are set to be connected.

In the present embodiment, as a defect classification apparatus that is different from the ADC apparatus 100, the MDC apparatus 104 is taken as an example to proceed with the description, but any apparatus that can assign a defect class to a defect that is image-captured in the defect image may be a defect classification apparatus or a defect analysis apparatus other than the MDC apparatus.

The inside of the ADC apparatus 100 will be described. The defect image capture apparatus 102, the yield management system 103, and the MDC apparatus 104 transmits and receives defect image data, the defect class information, and the like, through a data transmission and reception unit 110.

The ADC apparatus 100 includes the data transmission and reception unit 110, a storage unit 111, a defect class comparison unit 112, an image selection unit 113, a classification performance evaluation unit 114, an image classification unit 115, a learning update unit 116, an input and display terminal 117, and a bus 118.

Stored in the storage unit 111 are the defect image data, the defect class information, and the like. The defect class comparison unit 112 performs comparison among a plurality of defect classes for the same defect image that is obtained in other than the ADC apparatus 100, or comparison of a defect class that is obtained as a result of the comparison and a defect class that is assigned in the image classification unit 115. Based on a defect that results from the comparison by the defect class comparison unit 112, the image selection unit 113 makes a selection of a defect image from among defect images that are stored in the storage unit 111.

Based on the comparison of the defect class that is obtained as a result of the comparison in the defect class comparison unit 112 and the defect class that is assigned in the image classification unit 115, the classification performance evaluation unit 114 makes an evaluation of classification performance of the image classification unit 115. Based on an evaluation result of the classification performance of the image classification unit 115 that is evaluated in the classification performance evaluation unit 114, the learning update unit 116 updates a recipe for ADC processing that is performed in the image classification unit 115. The input and display terminal 117 displays processing detail, and along with this, receives input of a setting value of the operator and the like.

The bus 118 performs information transmission and reception between each of the data transmission and reception unit 110, the storage unit 111, the defect class comparison unit 112, an image selection unit 113, a classification performance evaluation unit 114, the image classification unit 115, the learning update unit 116, and a display terminal 117, within the ADC apparatus 100. The ADC apparatus 100 may be equipped with any of the defect image capture apparatus 102, the yield management system 103, and the manual defect classification apparatus 104.

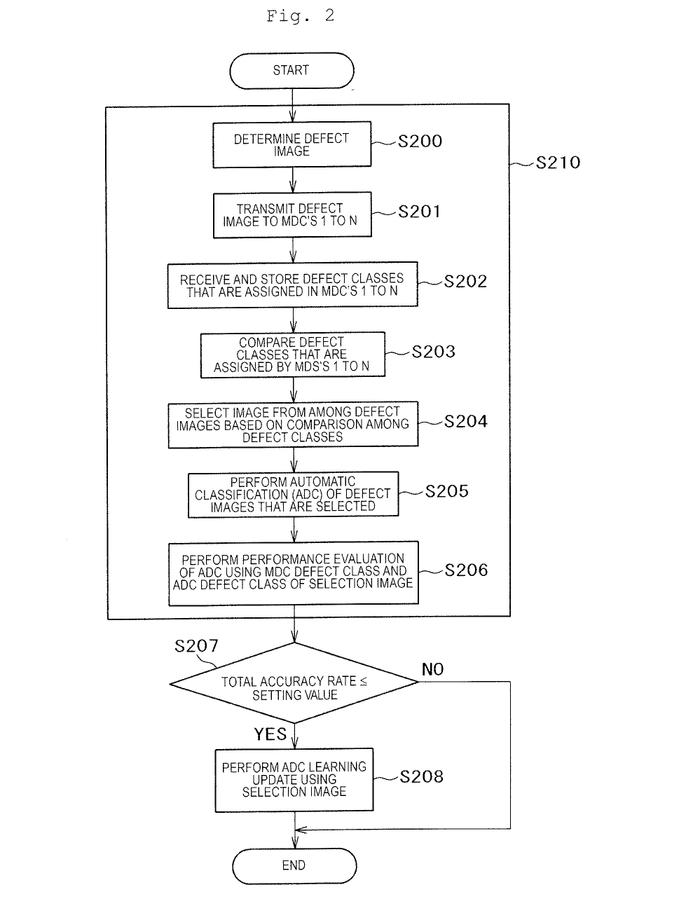

A flow for operation of the ADC apparatus 100 will be described in detail below with reference to FIG. 2. First, the defect image is determined (S200). The defect image here is one or more images that are targets for evaluation through this flow. The defect image may be one that results from reading what is image-captured in the defect image capture apparatus 102, and may be one that results from reading an image that has been registered with the yield management system 103. The defect image is an image that is obtained from one or more wafers.

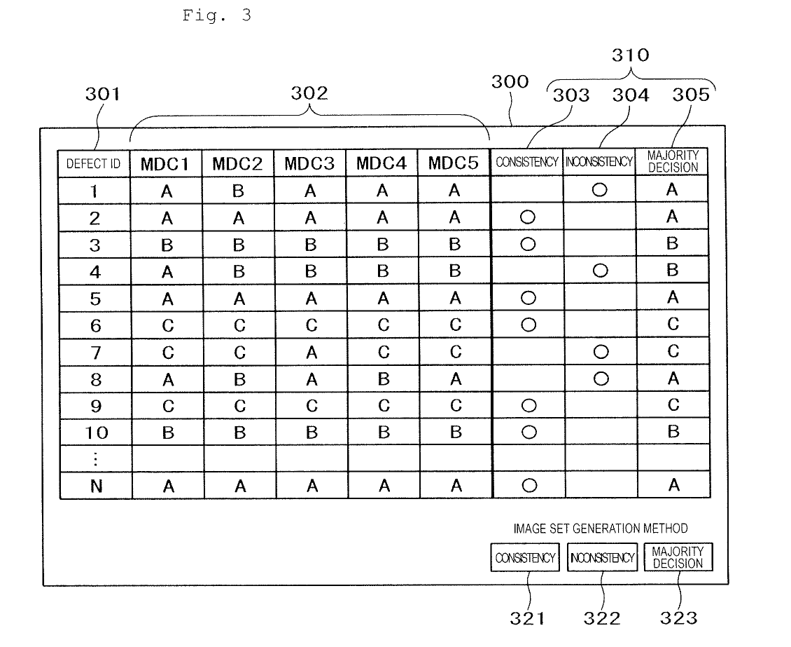

When the defect image is determined, the defect image is transmitted to a plurality of MDC apparatuses 104 (S201). The defect images are classified by the operator in each of the MDC apparatuses 104 (MDCs 1 To N), and the defect class is assigned. The assigned defect class information is received from the MDC apparatus 104 through the data transmission and reception unit 110, and is stored in the storage unit 111 (S202). Next, the defect classes that are assigned by the operator in each of the MDC apparatus 104 (MDCs 1 to N) are compared (S203). A method of the comparison will be described with reference to FIG. 3.

FIG. 3 illustrates information that is displayed a screen 300 of a display terminal 116. With regard to defect numbers 1, 2, and so forth up to N that are shown under a defect ID field 301, results of the classification in the MDC apparatuses 1, 2, 3, 4, and 5 that are shown under an MDC apparatus field 302 are shown under a classification result field 310. A, B, and C in a table denotes defect classes. With defect ID 1 under the defect ID field 301, information that is defect class B is received from the MDC apparatus 2 that is shown under the MDC apparatus field 302. Other MDC apparatuses fall under defect class A, and defect classes in the MDC apparatuses 1, 2, 3, 4, and 5 are inconsistent with each other.

On the other hand, with defect ID 2 under the defect ID field 301, information that is defect class A is received from all the MDC apparatuses that are shown under the MDC apparatus field 302, and the defect classes in the MDC apparatuses 1, 2, 3, 4, and 5 are consistent with each other. In a case where consistency is present, ο is placed under a “consistency” field 303 corresponding to each defect ID, which belongs to the classification result field 310. In a case where inconsistency is present, ο is placed under an “inconsistency” field 304.

It can be considered that the defect ID, the defect classes with which are consistent with each other has higher reliability of the defect class in the MDC than the defect ID, the defect classes with which are inconsistent with each other. It is noted that five MDC apparatuses are illustrated in FIG. 3, but that because this is convenient for description, any two or more sets of MDC apparatuses may be available. A defect class that is listed under a field that is a majority decision 305 that belongs to the classification result field 310 is a defect class that gains the greatest number of votes for the defect image among the MDCs. At least one or more that are selected from among selection buttons, consistency 321, inconsistency 322, and majority decision 323, may be displayed on the screen 300. Only consistency among MDC defect classes, or only information corresponding to the defect ID in which the inconsistency is present, may be displayed.

First, S203 in a flowchart in FIG. 2 and subsequent steps will be described below using a method that uses the consistency among the defect classes in FIG. 3. A method that uses the inconsistency and the majority decision in FIG. 3 will be described below.

The defect class that is assigned by each of the MDC apparatuses 104 (MDCs 1 to N) is read from the storage unit 111 into the defect class comparison unit 112 and the comparison is performed (S203). A defect number in which as a result of the comparison, the defect classes are consistent with each other is specified, and a defect image corresponding to the specified defect number is selected in the image selection unit 113 (S204).

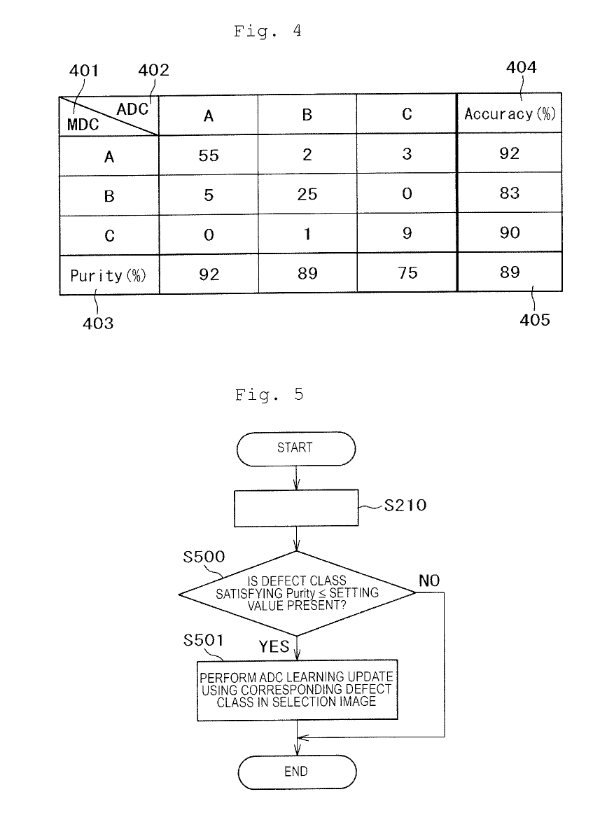

Next, the defect image that is selected in the image selection unit 113 is automatically classified in the image classification unit 115 (S205), and in the classification performance evaluation unit 114, performance evaluation of the ADC is performed using a defect class that is obtained with the automatic classification in the image classification unit 115 and an MDC defect class of a selection image (S206). Steps from S200 to S206 are collectively set to be S210 for reference in FIG. 5 and subsequent figures. In a case where the defect image that is selected in the image selection unit 113 has been automatically classified in the image classification unit 115, S205 can be omitted.

FIG. 4 illustrates a first example of the performance evaluation of the ADC that is performed in the classification performance evaluation unit 114. In a table in FIG. 4, in a vertical column 401, the defect class that is assigned by the MDC, is placed, and in a horizontal row 402, the defect class that is assigned by the ADC is placed. The performance relating to defect class “A” that is assigned by the ADC can be evaluated as purity performance 403, that is, (the number of true positives in defect class “A” that is assigned by the ADC)/(a total of the number of true positives and the number of false positives in defect class “A” that is assigned by the ADC)=55/(55+5+0)×100=92%. In a case where defect class “A” that is assigned by the ADC is assumed, this can be interpreted as having 92% reliability, and serves as an index of reliability.

Whether defect class “A” in the vertical column 401, which is assigned by the MDC, can be correctly classified in the ADC in the horizontal row 402 can be evaluated as accuracy performance 404, that is, (the number of true positives in defect class “A” that is assigned by the MDC)/(a total of the number of true positives and the number of false negatives in defect class “A” that is assigned by the MDC)=55/(55+2+3)×100=92%. This serves as an index indicating to what accuracy the ADC can perform the classification by comparison with the MDC. The same is true for other defect classes “B” and “C” in terms of accuracy and purity.

A total accuracy rate is shown under a field 405 in FIG. 4. The total accuracy rate is (the number of true positives)/(a total of all samples)=(55+25+9)/(55+2+3+5+25 +1+9)=89%.

The total accuracy rate that is illustrated in the field 405 in FIG. 4 is compared with a setting value that is in advance registered (S207), in a case where the total accuracy rate is equal to or lower than the setting value, that is, in a case where classification performance is low, ADC learning is performed with the image that is selected in S204 (S208). In a case where the total accuracy rate is equal to or lower than the setting value, an alarm which tells that the total accuracy rate is equal to or lower than the setting value, or the total accuracy rate, the setting values, and the like are displayed on the display terminal 116 in FIG. 1 for alarming. In a case where an input instruction from the user is present, proceeding to learning update of the ADC (S208) may take place. At this point, the learning update of the ADC is an adjustment of the recipe for the ADC processing.

FIG. 5 illustrates a method of comparing a first ADC performance value and the setting value, which is different from that in S207 and S208. S210 represents a step that has the same range as in S210 that is illustrated in FIG. 2, that is, steps from S200 to S206.

In the method in FIG. 5, purity 403 that is illustrated in FIG. 4 is compared with the setting value for every defect class (S500), and the learning update of the ADC from the image that is selected in S204 is performed using only an image in a defect class (a defect class in which the classification performance is low) corresponding to purity that is equal to or lower than the setting value (S501). In a case where a defect class that corresponds to purity which is equal to or lower than the setting value is present, an alarm is issued to the display terminal 116, and in a case where the input instruction from the user is present, the proceeding to the learning update of the ADC (S501) may take place.

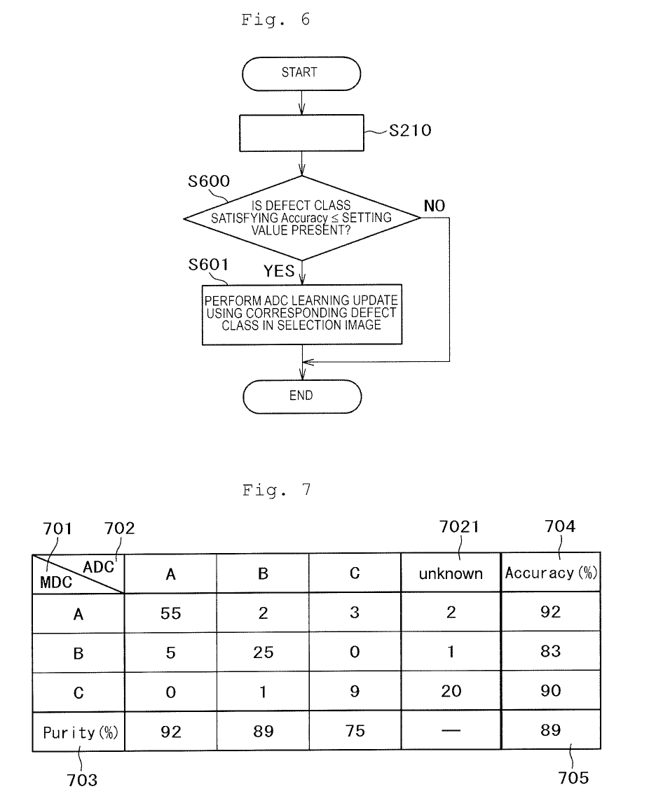

FIG. 6 illustrates a method of comparing a second ADC performance value and the setting value, which is different from that in S207 and S208. In the method in FIG. 6, accuracy 404 that is illustrated in FIG. 4 is compared with the setting value for every defect class (S600), and the learning update of the ADC from the image that is selected in S204 is performed using only an image in a defect class (a defect class in which the classification performance is low) corresponding to accuracy that is equal to or lower than the setting value (S601). In a case where the defect class corresponding to the accuracy that is equal to or lower than the setting value is present, the alarm is issued to the display terminal 116, and in a case where the input instruction from the user is present, the proceeding to the learning update of the ADC (S601) may take place.

FIG. 7 illustrates a second example of the performance evaluation of the ADC. In a table in FIG. 7, as in the table that is described with reference to FIG. 4, a defect class which is assigned by the MDC is shown under a vertical column 701, a defect class that is assigned by the ADC is shown in a horizontal row 702, and purity 703 is shown in the lowermost horizontal row, accuracy 704 in the rightmost vertical column and the total accuracy rate in a lowermost and rightmost box 705.

In the table in FIG. 7, when compared with the table in FIG. 4, unknown class (unknown defect class) 7021 is added to defect classes in the horizontal row 702, which are assigned by the ADC. Unknown class 7021 is a class that is provided for assignment in a case where it is determined by the ADC that a border case of a defect class learned or a case that does not correspond to the defect class learned is present. In an example in FIG. 7, a case where unknown class 7021 is set to be explicitly identified by the ADC and is not reflected in calculation of accuracy 704 is illustrated.

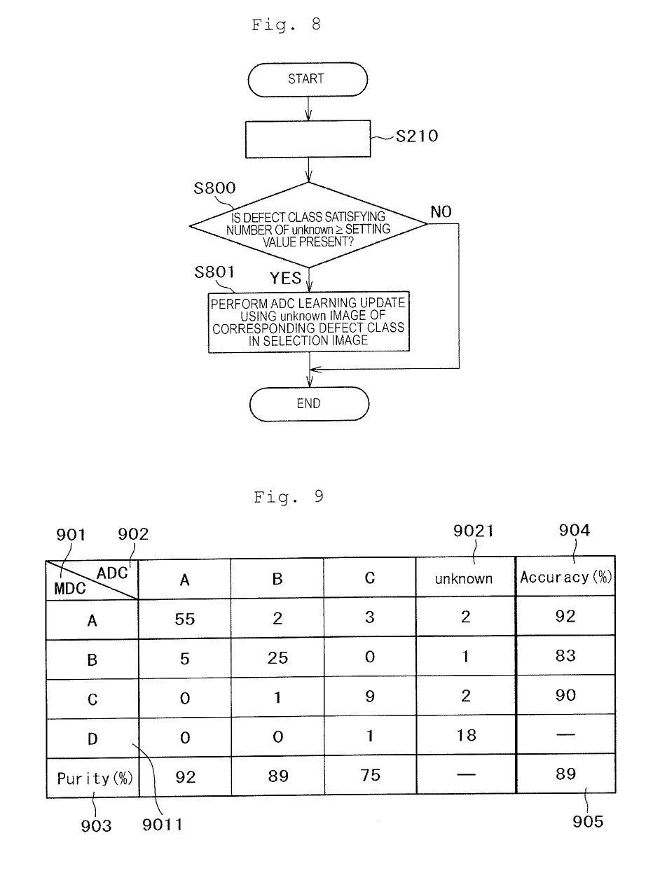

FIG. 8 illustrates an ADC method of the learning update of the ADC that uses unknown. After performing processing in S210, the number of images that are determined by ADC, as being unknown, with each defect class that is assigned by the MDC, is compared with a setting value that is in advance registered (S800). If the number of images that are determined, as being unknown, with the MDC defect classes is equal to or greater than the setting value, the learning update of the ADC from the image that is selected in S204 is performed using the images that are determined as being unknown, with the MDC defect classes that are assigned by the MDC (S801). The learning update of the ADC may be performed using all the images to which the MDC defect class is assigned.

Accordingly, the ADC classification robustness of the defect class can be improved and a decrease in unknown can be accomplished. In a case where the number of images that are determined, as being unknown, with the MDC defect classes is equal to or greater than the setting value, an alarm is issued to the display terminal 116, and in the case where the input instruction from the user is present, the proceeding to the learning update of the ADC (S801) may take place.

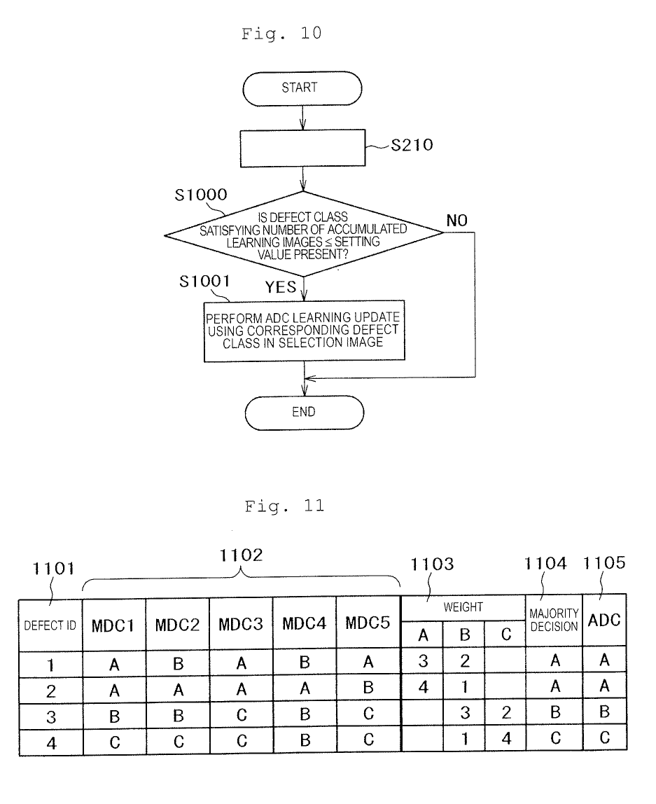

FIG. 9 is an example in a case where a new defect class D is appeared. In a configuration of a table in FIG. 9, as in the configuration that is described with reference to FIG. 7, a defect class which is assigned by the MDC is shown under a vertical column 901, a defect class that is assigned by the ADC is shown in a horizontal row 902, and purity 903 is shown in the lowermost horizontal row, accuracy 904 in the rightmost vertical column and the total accuracy rate in a lowermost and rightmost box 905. A new defect class can be identified as a class D9011 in the MDC in the vertical column 901 in the table that is illustrated in FIG. 9, but because there is no instruction in the ADC in the vertical column 902, the new defect class is an unknown class 9021. The learning update of the ADC is performed such that an image that is set to be a defect class in the MDC in the vertical column 901, which is the D9011, and that is the unknown class 9021 in the ADC in the vertical column 902, is set to be the defect class D, and thus it is possible that the defect class D is additionally registered in the ADC.

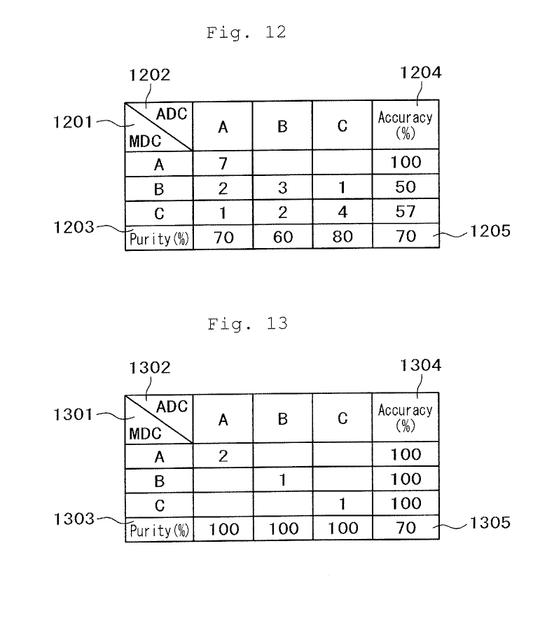

In order to deepen the learning of the ADC, the fixed number of defect images or greater needs to be taught for every defect class. This method is illustrated in FIG. 10. In a flow that is illustrated in FIG. 10, after the processing in S219 that is described with reference to FIG. 2 is performed, the number of accumulated learning images to which each defect class is assigned is recorded and the number of accumulated images is compared with a setting value (S1000). In a case where the number of accumulated images is equal to or smaller than the setting value, the learning update of the ADC from the image that is selected in S204 is performed using all or one or several images to which the MDC defect class is assigned (S1001). With this method, a problem with the defect class that falls short of the number of learning images can be solved. In a case where the number of accumulation images to which the defect class is assigned is equal or smaller than a setting value, an alarm is issued to the display terminal 116, and in the case where the input instruction from the user is present, the proceeding to the learning update of the ADC (S1001) may take place.

In FIGS. 4 to 10, the method of selecting the image of which the defect classes are consistent with each other is described, but in a case where the defect that is determined by the majority decision in FIG. 3 is used, a defect class with each defect ID that is used in the image selection in S204 in FIG. 2 may be set to be a defect class that is obtained as a result of the majority decision. If the result of the majority decision is used, all images that are determined in S200 can be used.

FIG. 11 illustrates a method in which weight is considered, as the method of comparing the defect classes. A table that is illustrated in FIG. 11 is configured to include a field 1101 under which the defect ID is shown, a field 1102 under which a result of the MDC for every MDC apparatus is shown, a field 1103 under which the weight is shown, afield 1104 under which the result of the majority decision for every defect ID is shown, and a field 1105 under which a result of the ADC for every defect ID. FIG. 11 illustrates results of the classification by MDC apparatuses 1, 2, 3, 4, and 5 under the MDC apparatus field 1102, for defect numbers 1, 2, 3, and 4 under the defect ID field 1101. The number of defects is set to 4 for description simplification, but the number of defects is not limited to this. A, B, and C in a table denotes defect classes. The way to understanding the defect ID field 1101 and the defect classes under the MDC apparatus field 1102 is the same as that in FIG. 3.

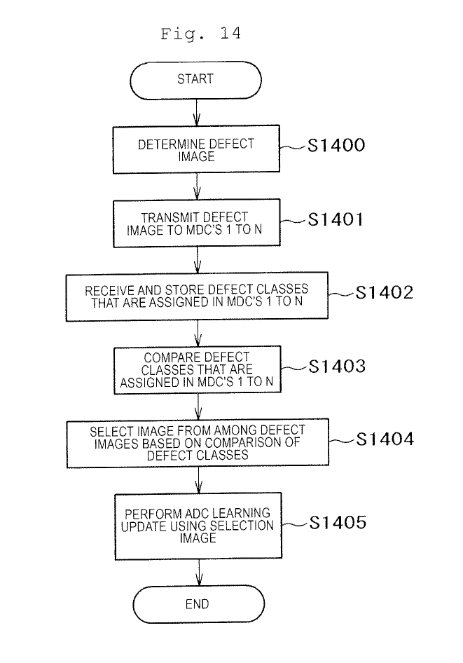

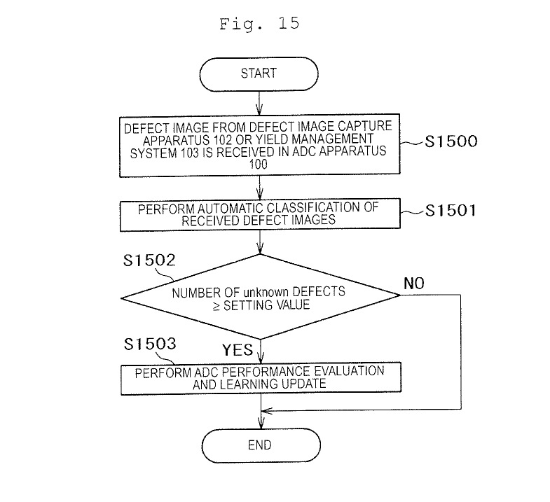

For consideration of the weight, the weight field 1103 is shown in the table that is illustrated in FIG. 11. In an example that is illustrated in FIG. 11, in the defect ID 1 under the defect ID field 1101, the number of determinations of defect classes A by the MDC under the MDC apparatus field 1102 is 3, and the number of determinations of defect classes B by the MDC under the MDC apparatus field 1102 is 2. The number of determinations, as they are, are used as a weight value under the weight field 1103. Similarly, for the defect IDs 2, 3, and 4, summarization can also be provided as illustrated in FIG. 11. A defect class that is written under a majority decision field 1104 in the table in FIG. 11 is the one that is determined with the majority decision method that is described with reference to FIG. 3. The class is uniquely determined, but in the defect ID 1 or 4, it is not known that there are other contending defect classes. At this point, with classes, which are obtained by performing ADC processing in defect IDs 1, 2, 3, and 4 in FIG. 11, as classes that are shown under an ADC field 1105, an effect in a case where performance evaluation of the ADC is performed considering the weight is described with reference to FIGS. 12 and 13.

FIG. 12 illustrates a case where the performance evaluation of the ADC is performed considering the weight. In a configuration of a table that is illustrated in FIG. 12, which is the same as that which is described with reference to FIG. 4, a defect class that is assigned by the MDC is shown under a vertical column 1201, a defect class that is assigned by the ADC is shown in a horizontal row 1202, and purity performance 1203 is shown in the lowermost horizontal row, accuracy performance 1204 in the rightmost vertical column and the total accuracy rate in a lowermost and rightmost box 1205. In the example that is illustrated in FIG. 11, in defect ID 1 under the defect ID field 1101, three MDC defect classes A are present, two MDC defect classes B are present, and the ADC defect class is A. Because of this, three votes are cast for “MDC defect class A/ADC defect class A” in a matrix in FIG. 12 and two votes are cast for “MDC defect class B/ADC defect class A”. FIG. 12 illustrates a result that is obtained by performing the same processing also on defect IDs 2, 3, and 4.

On the other hand, FIG. 13 illustrates a result that is obtained by performing the evaluation using the defect class that is determined as a result of the majority decision. In a configuration of a table that is illustrated in FIG. 13, which is the same as that which is described with reference to FIG. 4, a defect class that is assigned by the MDC is shown under a vertical column 1301, a defect class that is assigned by the ADC is shown in a horizontal row 1302, and purity performance 1303 is shown in the lowermost horizontal row, accuracy performance 1304 in the rightmost vertical column and the total accuracy rate in a lowermost and rightmost box 1305. As illustrated in FIG. 13, in a case where the evaluation is performed using the defect class that is determined as a result of the majority decision, the ADC provides a 100% correct solution.

In a case where there is no example in which MDC defect classes are consistent with each other and where a few of such samples are present, one technique is to perform the performance evaluation of the ADC from results of a plurality of MDCs from the perspective of the classification without inclining to a specific person's preference. The performance of the ADC that has to be enhanced is not seen from a result in FIG. 13. On the other hand, from the result in FIG. 12, it is understood that additional learning is a high priority for the defect class B, in terms of both the purity 1203 and the accuracy 1204. When the additional learning is performed, it is considered that image to which the same defect ID is assigned is learned a plurality of times with the defect class that is assigned by the MDC, and so forth. For example, in the case of defect ID 1, an image with defect ID 1 is caused to be learned three times as the defect class A, and to be learned two times as the defect class B.

When it comes to a timing at which the performance evaluation and the learning data set update of the ADC that is illustrated in FIGS. 2 to 10 is performed while being applied to production, in addition to explicit activation by an operator, a method that uses the number of images that are classified into the unknown class that is assigned by the ADC, an automatic activation method such as a periodical performance is used.

### Second Embodiment

Next, in the processing flow that is illustrated in FIG. 2, which is described in the first embodiment, a processing method in which the result of the MDC is reflected in the learning of the ADC without performing the performance evaluation of the ADC will be described with reference to a flow diagram that is illustrated as a second embodiment in FIG. 14.

That is, in the first embodiment, the ADC is performed on the image that is selected based on the result of the MDC and thus the performance evaluation of the ADC is performed, and in a case where the total accuracy rate of the ADC is equal to or lower than a setting value, the ADC is learning-updated based on the image that is selected based on the result of the MDC. In contrast, in the present embodiment, the ADC is set to be immediately learning-updated based on the image that is selected based on the result of the MDC without performing the performance evaluation of the ADC.

A configuration of an automatic defect classification apparatus in the present embodiment is a configuration that results from excluding the classification performance evaluation unit 114 from the configuration that is described in the first embodiment with reference to FIG. 1, and because other constituents are the same as those described with reference to FIG. 1, descriptions thereof are omitted.

Because Steps from S1400 to S1404 in FIG. 14 are the same as those from S200 to S204 in the flow in FIG. 2, which are descried in the first embodiment, descriptions thereof are omitted.

In the present embodiment, in S1403, a defect number in which the defect classes are consistent with each other is specified with the comparison method as described with reference to FIG. 3, a defect image that corresponds to the defect number which is specified in S1404 is selected in the image selection unit 113, the learning update of the ADC is performed in the learning update unit 116 using the image that is selected in the image selection unit 113 in S1405, and the recipe for the ADC processing that is performed in the image classification unit 115 is adjusted.

According to the first embodiment, the result from the majority decision that uses a plurality of defect classification means or a plurality of defect classification results is automatically reflected in a database of an automatic defect classification unit, from the standpoint in the past that the result of the defect determination by a human being is correct. In contrast, in the present embodiment, the database of the automatic defect classification apparatus is improved based on the result of the majority decision, from the completely-opposite standpoint that a human being has an individual difference and a result varies depending on the human difference, and thus, an exceedingly remarkable operation that can realize the accuracy of the defect classification which is such that the human visual defect classification is exceeded can be accomplished with the automatic defect classification.

### Third Embodiment

In the first and second embodiments, the processing is performed on the assumption that the MDC is first performed on the defect image, but in the present embodiment, processing that performs the MDC only in a case where the ADC is first performed on the defect image in the preceding processing, and thus where the number of unknown defects that cannot be classified into defects is equal to or greater than a setting value, and periodic activation will be described. Because a configuration of the automatic defect classification apparatus in the present embodiment is the same as that which is described with reference to FIG. 1 in the first embodiment, a description thereof is omitted.

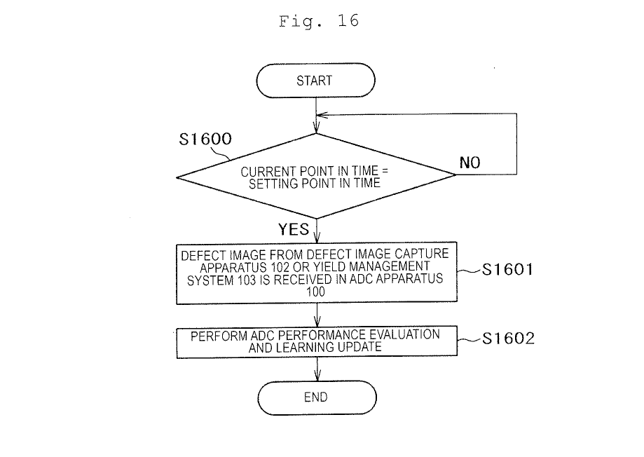

FIG. 15 illustrates a processing flow in a case where the activation is performed with the number of images that are classified into the unknown class by the ADC in the present embodiment. First, the defect image from the defect image capture apparatus 102 or the yield management system 103 is received in the ADC apparatus 100 (S1500), and the received defect image is classified in the image classification unit 115 of the ADC apparatus 100 (S1501). The number of images that are classified into the unknown class, which is obtained as a result of the classification is compared with a setting value that is in advance registered (S1502), and in a case where the number of images that are classified into the unknown class is equal to or greater than the setting value, the performance evaluation and the additional learning of the ADC, which are described with reference to FIGS. 2 to 10 in the first embodiment, are performed (S1503). In a case where the image that is received in Step S1500 is set to be a target image (that is, the defect image in S200) in S1503, the ADC processing in S205 in FIG. 2 may be skipped. Furthermore, with an image that is different from the image which is received in S1500, S1503 may be performed.

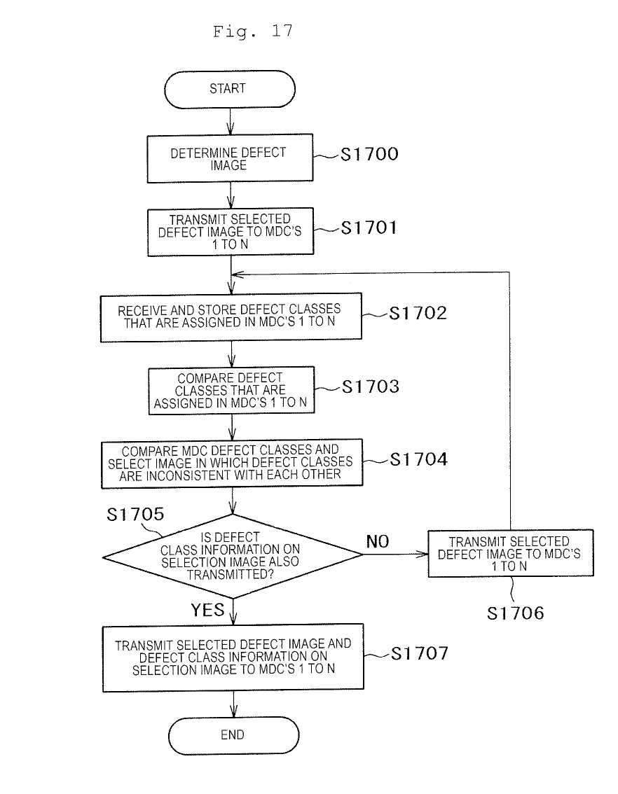

FIG. 16 illustrates a processing flow in a case where the activation is periodically performed. First, a current point in time that is managed in the ADC apparatus is compared with a setting point in time that is in advance registered (S1600), the defect image from the defect image capture apparatus 102 or the yield management system 103 is received in the ADC apparatus 100 when the current point in time is the setting point in time (S1601), and the performance evaluation and the additional learning of the ADC, which are described with reference to FIGS. 2 to 10 in the first embodiment, are performed (S1602). It is noted that instead of the setting point in time that is registered, the elapsed time from the previous performance evaluation or additional learning of the ADC may be registered, and that a point in time that results from adding the registered elapsed time to the previous performance evaluation or additional learning of the ADC may be set to be the setting point in time. Accordingly the periodic performance evaluation and learning update of the ADC can be performed.

As described above, with the comparison among a plurality of MDC defect classes, because the MDC defect class that results from excluding the individual difference in visual review can be obtained, high-reliability ADC performance evaluation and the additional learning of the ADC are possible.

### Fourth Embodiment

In a fourth embodiment, a method of using the inconsistency among the MDC defect classes, which is described with reference to FIG. 3 in the first embodiment will be described. It can be understood that with regard to an operational level of a visual classification operator varies among defect IDs 1, 4, 7, and 8 in which the MDC defect classes are inconsistent with each other in FIG. 3. In the present embodiment, this image is again returned to the MDC apparatus, and thus standardization of the operational level of the visual classification operation is accomplished.

A processing flow in the fourth embodiment will be described with reference to FIG. 17. First, a defect image is determined (S1700). The defect image is the same that the image that is determined in S200, which is described with reference to FIG. 2 in the first embodiment. Alternatively, an image that is intentionally selected for training of the operator may be available. When the defect image is determined, the defect image is transmitted to a plurality of MDC apparatuses 104 (S1701). The defect images are classified by the operator in each of the MDC apparatuses 104 (MDCs 1 To N), and the defect class is assigned. The assigned defect class information is received from the MDC apparatus 104 through the data transmission and reception unit 110, and is stored in the storage unit 111 (S1702).

Next, the defect class that is assigned by each of the MDC apparatuses 104 (MDCs 1 to N) is read from the storage unit 111 into the defect class comparison unit 112 and the comparison is performed (S1703). A defect number in which as a result of the comparison, the defect classes are inconsistent with each other is specified, and a defect image corresponding to the specified defect number is selected (S1704). A method of extracting the inconsistency among the defect classes as a result of the comparison is as described with reference to FIG. 3 in the first embodiment.

In the steps from S1700 to S1704, which are described above, the same processing operations as in the steps from S200 to S204, which are described with reference to FIG. 2 in the first embodiment are performed.

With regard to image data in which the selected MDC defect classes are inconsistent with each other, it is checked whether the defect class information is also transmitted (S1705). In a case where a defect class that is determined by a skilled operator is not disclosed as a response to an operator (in the case of NO in S1705), the defect image that is again selected is transmitted to the MDCs 1 to N and the operator is requested to perform an MDC operation (S1606). In a case where the defect class that is determined by the skilled operator is disclosed as the response to the operator (in the case of YES in S1705), the selected defect image and defect class information of a selection image are transmitted to the MDCs 1 to N, and the operator is caused to check these (S1607).

Using this result, the performance evaluation of the ADC is performed according to the processing flow that is described with reference to FIG. 2 in the first embodiment, and the learning update of the ADC is performed. Furthermore, as described in the second embodiment, the learning update of the ADC is performed using the defect image that is selected according to the processing flow in FIG. 14.

According to the present embodiment, the image in which the MDC defect classes are inconsistent with each other is caused to be checked by the operator, and thus the variation in the operational level of the operator can be reduced, and the standardization of the operational level can be accomplished.

### Reference Signs List

100 AUTOMATIC DEFECT CLASSIFICATION APPARATUS
101 COMMUNICATION NETWORK
102 DEFECT IMAGE CAPTURE APPARATUS
103 YIELD MANAGEMENT SYSTEM
104 VISUAL DEFECT CLASSIFICATION UNIT
110 DATA TRANSMISSION AND RECEPTION UNIT
111 STORAGE UNIT
112 DEFECT CLASS COMPARISON UNIT
113 IMAGE SELECTION UNIT
114 CLASSIFICATION PERFORMANCE EVALUATION UNIT
115 IMAGE CLASSIFICATION UNIT
116 INPUT AND DISPLAY TERMINAL
117 BUS

1. A defect image classification apparatus that classifies defect images, comprising:
a storage unit in which the defect images that are obtained by being captured in separate image capture means are stored;
an image selection unit that selects images from among the defect images that are stored in the storage unit, using information on defect classes into which defects are classified in a plurality of separate defect classification means;
an image classification unit that classifies the images which are selected in the image selection unit, based on a classification recipe;
a classification performance evaluation unit that evaluates classification performance of the image classification unit based on a result of the classification of the images; and
a learning update unit that updates the classification recipe of the image classification unit using the images that are selected in the image selection unit in a case where the result of the evaluation in the classification performance evaluation unit does not satisfy a reference that is in advance set.

2. The defect image classification apparatus that classifies defect images according to claim 1, further comprising:
a defect class comparison unit that compares defect classes that result from the classification in the plurality of separate defect classification means,
wherein the images are selected in the image selection unit from among the defect images that are stored in the storage unit, based on information that results from the comparison in the defect class comparison unit.

3. The defect image classification apparatus that classifies defect images according to claim 1,
wherein the learning update unit updates the classification recipe of the image classification unit using a defect image that is determined as an unknown defect class in the image classification unit, among the images that are selected in the image selection unit, in a case where the result of the evaluation in the classification performance evaluation unit does not satisfy the reference that is in advance set.

4. The defect image classification apparatus that classifies defect images according to claim 1,
wherein the image classification unit classifies the defect images that are obtained by being captured in the separate image capture means, which are stored in the storage unit, based on the classification recipe, and
wherein, in a case where the number of defects that are determined as an unknown defect class as a result of the classification in the image classification unit is equal to or greater than a number that is in advance set, the image selection unit selects an image from among the defect images that are stored in the storage unit, using the information on the defect classes into which the defects are classified in the plurality of separate defect classification means.

5. The defect image classification apparatus that classifies defect images according to claim 1,
wherein the separate image capture means and the plurality of separate defect classification means are connected to each other through a communication line.

6. A defect image classification apparatus that classifies defect images, comprising:
a storage unit in which the defect images that are obtained by being captured in separate image capture means are stored;
an image selection unit that selects images from among the defect images that are stored in the storage unit, using information on defect classes into which defects are classified in a plurality of separate defect classification means;
an image classification unit that classifies the images which are stored in the storage unit, based on a classification recipe; and
a learning update unit that updates the classification recipe of the image classification unit using the images that are selected in the image selection unit.

7. The defect image classification apparatus that classifies defect images according to claim 6, further comprising:
a defect class comparison unit that compares defect classes that result from the classification in the plurality of separate defect classification means,
wherein the images are selected in the image selection unit from among the defect images that are stored in the storage unit, based on information that results from the comparison in the defect class comparison unit.

8. The defect image classification apparatus that classifies defect images according to claim 6,
wherein the learning update unit updates the classification recipe of the image classification unit using a defect image that is determined as an unknown defect class in the image classification unit, among the images that are selected in the image selection unit, in a case where the result of the evaluation in the classification performance evaluation unit does not satisfy the reference that is in advance set.

9. The defect image classification apparatus that classifies defect images according to claim 6,
wherein the image classification unit classifies the defect images that are obtained by being captured in the separate image capture means, which are stored in the storage unit, based on the classification recipe, and
wherein, in a case where the number of defects that are determined as an unknown defect class as a result of the classification in the image classification unit is equal to or greater than a number that is in advance set, the image selection unit selects an image from among the defect images that are stored in the storage unit, using the information on the defect classes into which the defects are classified in the plurality of separate defect classification means.

10. The defect image classification apparatus that classifies defect images according to claim 6,
wherein the separate image capture means and the plurality of separate defect classification means are connected to each other through a communication line.

11. A defect image classification method of classifying defect images, comprising:
storing the defect images that are obtained by being captured in separate image capture means, in a storage unit;
selecting images in an image selection unit from among the defect images that are stored in the storage unit, using information on defect classes into which defects are classified in a plurality of separate defect classification means;
classifying the images which are selected in the image selection unit, in an image classification unit, based on a classification recipe;
evaluating classification performance of the image classification unit, in a classification performance evaluation unit, based on a result of the classification of the images; and
updating the classification recipe of the image classification unit, in a learning update unit, using the images that are selected in the image selection unit in a case where the result of the evaluation in the classification performance evaluation unit does not satisfy a reference that is in advance set.

12. The defect image classification method of classifying defect images according to claim 11, further comprising:
a process of comparing defect classes that result from the classification in the plurality of separate defect classification means, in a defect class comparison unit,
wherein the images are selected in the image selection unit from among the defect images that are stored in the storage unit, based on information that results from the comparison in the defect class comparison unit.

13. The defect image classification method of classifying defect images according to claim 11,
wherein the updating of the classification recipe that is performed in the learning update unit includes updating the classification recipe of the image classification unit, using a defect image that is determined as an unknown defect class in the image classification unit, among the images that are selected in the image selection unit, in a case where the result of the evaluation in the classification performance evaluation unit does not satisfy the reference that is in advance set.

14. The defect image classification method of classifying defect images according to claim 11,
wherein the defect images that are obtained by being captured in the separate image capture means, which are stored in the storage unit, are classified in the image classification unit, based on the classification recipe, and
wherein, in a case where the number of defects that are determined as an unknown defect class as a result of the classification in the image classification unit is equal to or greater than a number that is in advance set, an image from among the defect images that are stored in the storage unit is selected in the image selection unit, using the information on the defect classes into which the defects are classified in the plurality of separate defect classification means.

15. The defect image classification method of classifying defect images according to claim 11,
wherein information from each of the separate image capture means and the plurality of separate defect classification means is acquired through a communication line.

16. A defect image classification method of classifying defect images, comprising:
storing the defect images that are obtained by being captured with separate image capture means, in a storage unit;
selecting images in an image selection unit from among the defect images that are stored in the storage unit, using information on defect classes into which defects are classified in a plurality of separate defect classification means;
classifying the images which are stored in the storage unit, in an image classification unit, based on a classification recipe; and
updating the classification recipe of the image classification unit in a learning update unit, using the images that are selected in the image selection unit.

17. The defect image classification method of classifying defect images according to claim 16, further comprising:
a process of comparing defect classes that result from the classification in the plurality of separate defect classification means, in a defect class comparison unit,
wherein the images are selected in the image selection unit from among the defect images that are stored in the storage unit, based on information that results from the comparison in the defect class comparison unit.

18. The defect image classification method of classifying defect images according to claim 16,
wherein the updating of the classification recipe that is performed in the learning update unit includes updating the classification recipe of the image classification unit, using a defect image that is determined as an unknown defect class in the image classification unit, among the images that are selected in the image selection unit, in a case where the result of the evaluation in the classification performance evaluation unit does not satisfy the reference that is in advance set.

19. The defect image classification method of classifying defect images according to claim 16,
wherein the defect images that are obtained by being captured in the separate image capture means, which are stored in the storage unit, are classified in the image classification unit, based on the classification recipe, and
wherein, in a case where the number of defects that are determined as an unknown defect class as a result of the classification in the image classification unit is equal to or greater than a number that is in advance set, an image from among the defect images that are stored in the storage unit is selected in the image selection unit, using the information on the defect classes into which the defects are classified in the plurality of separate defect classification means.

20. The defect image classification method of classifying defect images according to claim 16,
wherein information from each of the separate image capture means and the plurality of separate defect classification means is acquired through a communication line.
